(19) United States
(12) Patent Application Publication
(10) Pub. No.: US 2009/0044786 A1
(43) Pub. Date: Feb. 19, 2009

(54) Efficient Reduced-Emissions Carburetor

(76) Inventor: Georg B.L. Adams, Duchesne, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/839,354

(22) Filed: Aug. 15, 2007

(51) Int. Cl. F02M 19/06

(52) U.S. Cl. 123/538; 261/78.1; 261/81; 261/DIG. 48

(57) ABSTRACT

Carburetors for attaching to fuel-burning engines are described. The carburetors generate improved engine efficiency and reduced engine emissions by improving combustion of fuel. The carburetors include a plurality of nebulizers, each of which nebulizes a thin film of fuel covering a vibrating plate. The vibrating plate vibrates at a high frequency, and this vibration ejects a fog or mist of fuel particles into an air/fuel mixture channel that passes above the nebulizers in series. Air is drawn into the air/fuel mixture channel, passes over each of the plurality of nebulizers in turn, and then passes to a nebulized fuel outlet within a Venturi narrowing of a main channel of the carburetors. The Venturi narrowing provides a reduced air pressure area that performs the function of drawing the air through the air/fuel mixture channel over the nebulizers, thus drawing out the mixed air and nebulized fuel.

### BACKGROUND OF THE INVENTION

1. Field of the Invention

The present invention relates to carburetors, and more particularly to high-efficiency carburetors that more completely burn gas and produce fewer emissions.

2. Background and Related Art

In the usual internal combustion engine, or the like, the fuel is normally introduced into the carburetor for mixing with an air stream, and the fuel-air mixture is directed to the manifold and to the combustion chamber for burning. The carburetor operates on a simple physical principal wherein air drawn into the engine by the downward suction of a piston enters the top of the carburetor bore and travels downwardly therethrough, and through a Venturi. A main fuel nozzle communicates between a bowl of fuel and the interior of the carburetor in the proximity of the Venturi, and as the air passes through the Venturi, the speed of the flow stream increases and the pressure drops slightly in the Venturi. The drop in pressure pulls the fuel from the fuel bowl for injection into the carburetor bore through the nozzle, whereupon the fuel mixes with the air stream, forming a fine spray of atomized particles. This air-fuel mixture passes through the carburetor into the intake manifold, whereupon the fuel-air mixture is distributed to the engine cylinders for compression and combustion.

It is recognized that one secret of fuel economy is directly related to the ratio of air to fuel, and the efficient vaporization of the fuel-air mixture prior to burning thereon in order to achieve a more complete burning of the fuel for efficient use of the fuel and reduction of pollutants released into the atmosphere. Many efforts have been and are being made to improve the fuel efficiency. For example, a sonic apparatus has been developed wherein the fuel is disturbed by high-frequency energy for decomposition to the fuel to produce a substantial “cloud” of fuel. This reduction of fuel particles to such small sizes, and of relatively uniform particle size, increases the combustion efficiency. However, even with this improved procedure, there is still fuel loss and pollution resulting from unburned elements of the fuel.

Emissions from conventional internal combustion gasoline engines are formed when hydrocarbon fuel, such as gasoline, is burned incompletely into hydrocarbon (HC) and carbon oxides (CO). The formation of pollutant CO, HC and nitrous oxide (NOₓ) is a function of the proportional amounts of air and fuel introduced into the combustion chamber. Lean air-to-fuel ratios generally have decreased CO and HC emissions because of the greater quantity of oxygen available for combustion. When the air-to-fuel ratio becomes too rich, both HC and CO emissions increase.

NOₓ emissions are an exponential function of flame temperature. At low temperatures, nitrogen and oxygen will not unite to form any significant amount of NOₓ. Low temperatures are achieved at both rich and lean air-to-fuel ratios because of the dilutant effect exerted by unburned fuel in the rich case and the excess of air in the lean case. When the internal combustion engine operates at its stiochiometric point, the amount of fuel is matched exactly with the amount of oxygen for complete combustion. This point falls somewhere between 14.5 and 15 pounds of air per pound of fuel, and may vary somewhat depending on the type of fuel used.

Internal combustion engines will operate effectively at air-to-fuel ratios of 18:1 or even leaner ratios. The operation of the engine under these conditions is contingent on getting the right air-to-fuel mixture into all of the cylinders. With present carburetor technology, the air-to-fuel ratio of the fuel mixture to all of the cylinders is not constant. Some of the cylinders may be fed properly while others may be too lean and still others may be too rich. In any circumstance with fuel mixtures outside the desired range, there will be an increase in emissions.

### BRIEF SUMMARY OF THE INVENTION

Embodiments of the invention provide a carburetor for attaching to fuel-burning engines, such as are used for automobiles and other vehicles. The embodiments of the carburetor generate improved engine efficiency and reduced engine emissions by improving combustion of fuel. This is done by delivering a consistent, nebulized fuel at a desired air-to-fuel mixture appropriate for the specific engine and engine needs, such as 15:1 or 18:1. The nebulized fuel has a very small particle size that improves the mixture of air and fuel into a fog or mist of fuel in the air that is essentially unaffected by gravity over the short term. This mixture is directed to the engine and is then combusted. The improved mixture of air and fuel and small fuel particle size provides for efficient and fuller combustion. This improved combustion not only improves the efficiency of the engine, but also reduces emissions as fewer un-combusted fuel products remain after combustion.

The nebulized fuel is provided to the engine by the carburetor of embodiments of the invention. The carburetor includes a plurality of nebulizers that nebulize a thin film of fuel covering a vibrating plate. The vibrating plate of each of the nebulizers vibrates at a high frequency, such as at 2.4 megahertz (MHz), and this vibration ejects a fog or mist of fuel particles into an air/fuel mixture channel that passes above the nebulizers in serial fashion. Air is drawn into the air/fuel mixture channel, passes over each of the plurality of nebulizers in turn, gradually becoming fully supplied with nebulized fuel particles, before passing to a nebulized fuel outlet. The nebulized fuel outlet resides within a Venturi narrowing of a main channel of the carburetor, and the Venturi narrowing provides a reduced air pressure area that performs the function of drawing the air through the air/fuel mixture channel over the nebulizers, thus drawing out the mixture of air and nebulized fuel.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a plan/cross-sectional view of an embodiment of a carburetor along the line 24-24 of FIG. 2;

FIG. 2 shows a partial plan/partial perspective view of an embodiment of a carburetor;

FIG. 3 shows a perspective view of an embodiment of a main body of a carburetor from below;

FIG. 4 illustrates a partial perspective/partial plan view of an embodiment of a main body of a carburetor from above;

FIG. 5 shows a partial perspective/partial plan view of an embodiment of a main body of a carburetor from above;

FIG. 6 shows a cross-sectional view of the main body illustrated in FIG. 5 along the line 40-40;

FIG. 7 shows a perspective view of an embodiment of a main body of a carburetor from below;

FIG. 8 shows a cross-sectional view of the main body illustrated in FIG. 7 along the line 48-48;

FIG. 9 illustrates a perspective view of a top plate of a carburetor from above;

FIG. 10 illustrates a perspective view of the top plate of FIG. 9 from below;

FIG. 11 illustrates a cross-sectional view of the top plate of FIGS. 9 and 10 taken along the line 68-68;

FIG. 12 illustrates a cross-sectional view of the top plate of FIGS. 9-11 taken along the line 70-70 from FIG. 10; and

FIGS. 13-15 illustrate partial perspective/partial plan views of an embodiment of a base plate of a carburetor.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a carburetor for attaching to fuel-burning engines, such as are used for automobiles and other vehicles. The embodiments of the carburetor improve engine efficiency and reduce engine emissions by improving combustion of fuel. This is done by supplying a consistent, nebulized fuel at a desired air-to-fuel mixture appropriate for the specific engine and engine needs, such as 15:1, 18:1, or even higher. The nebulized fuel has a very small particle size that improves the mixture of air and fuel into a fog or mist of fuel in the air that is essentially unaffected by gravity over the short term. This mixture is delivered to the engine and is then combusted. The improved mixture of air and fuel and small fuel particle size provides for efficient and fuller combustion. This improved combustion not only improves the efficiency of the engine, but also reduces emissions as fewer un-combusted fuel products remain after combustion.

The nebulized fuel is delivered to the engine by the carburetor of embodiments of the invention. The carburetor includes a plurality of nebulizers, atomizers, or particle generators (“nebulizers”) that nebulize a thin film of fuel covering a vibrating plate. The vibrating plate of each of the nebulizers vibrates at a high frequency, generally over 1 MHz and such as at 2.4 MHz, and this vibration ejects a fog or mist of fuel particles into an air/fuel mixture channel that passes above the nebulizers in series fashion. Air is drawn into the air/fuel mixture channel, passes over each of the plurality of nebulizers in turn, gradually becoming fully supplied with nebulized fuel particles, before passing to a nebulized fuel outlet. The nebulized fuel outlet resides within a Venturi narrowing of a main channel of the carburetor, and the Venturi narrowing generates a reduced air pressure area that performs the function of drawing the air through the air/fuel mixture channel over the nebulizers, thus simultaneously drawing out the nebulized fuel mixed with air.

Nebulizers, atomizers, or particle generators (“nebulizers”) may be used for a variety of industry applications. For carburetion, the nebulized fuel can be transported in a mist or fog of microparticles from the carburetor to the combustion cylinders making automobiles more efficient, particularly in cold weather and over short distances.

There are a number of different types of nebulizers, including at least: (a) cross flow pneumatic nebulizers; (b) threaded cross flow nebulizers, (c) Babington-type nebulizers; (d) ultrasonic nebulizers; and (e) fretted or porous disk nebulizers.

The concept underlying ultrasonic nebulizing of liquids is simple. When ultrasonic energy is supplied to a liquid, capillary waves are generated. If enough ultrasonic energy is applied the waves rupture at the liquid surface to form aerosol-sized droplets. The ultrasonic nebulizer is that it has a tendency to generate aerosol in a cyclic manner. That is, cavitation develops between the surface having the ultrasonic input and the liquid. When this happens, energy is not transferred to the liquid.

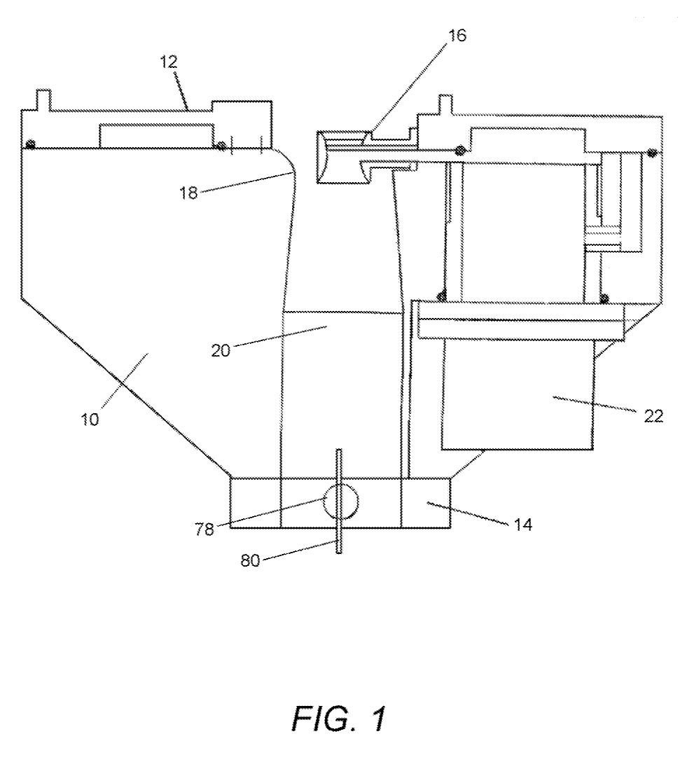

FIG. 1 shows a plan/cross-sectional view of an illustrative embodiment of a carburetor. The carburetor has a main body 10, a top plate 12 attached to the top of the body 10, and a base plate 14 attached to the bottom of the body 10. As may be appreciated by one of skill in the art, the main body 10, the top plate 12, and the base plate 14 may be manufactured from various materials, such as metals like steel or aluminum, and may be manufactured by casting, machining, etc. as necessary to provide the features discussed herein. The base plate 14 may be affixed to an engine, as is commonly known in the art. The carburetor also has a nebulized fuel outlet 16 located in a Venturi narrowing 18 of a main channel 20 passing vertically through the carburetor. The Venturi narrowing 18 reduces the pressure of air flowing through the main channel 20 at the location of the nebulized fuel outlet 16, which draws fuel and air into the air flowing through the main channel 20, as will be described in more detail below. Around the main channel 20 are a plurality of nebulizers 22 that nebulize incoming fuel into a fog or mist of very small fuel particles that better mix with incoming air and thereby provide better combustion and efficiency with fewer emissions.

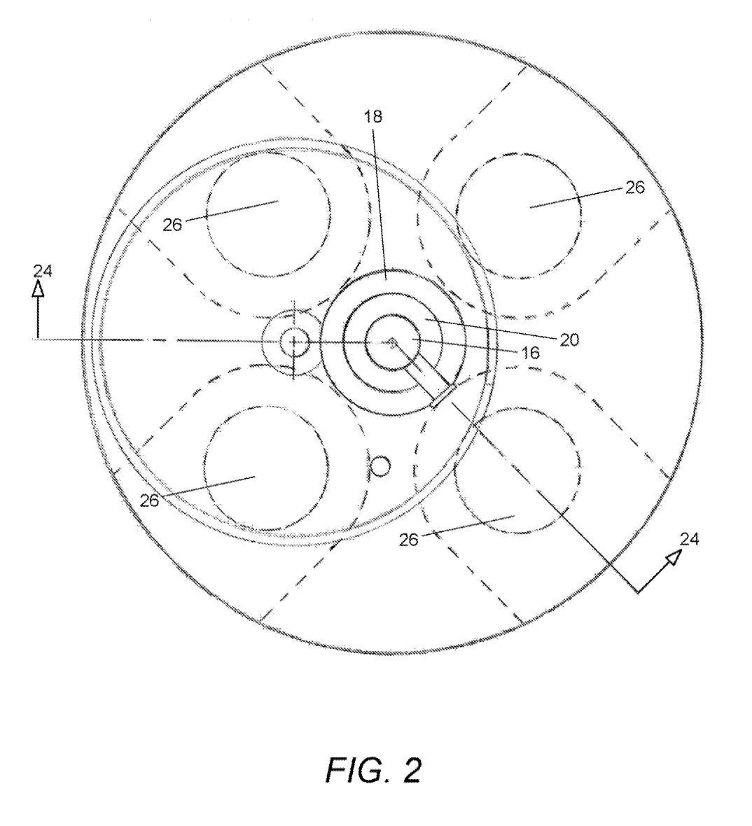

FIG. 2 shows a view of the carburetor from above, with several of the features shown in FIG. 1 illustrated in outline form. For clarity of illustration, some features of the top plate 12 are omitted from the view of FIG. 2. FIG. 2 also shows the cross-sectional line 24-24 through the carburetor to provide the plan view of FIG. 1. In the view of FIG. 2, the Venturi narrowing 18 of the main channel 20 may be seen, as well as the central location of the nebulized fuel outlet 16 in the Venturi narrowing 18. FIG. 2 also illustrates the radial locations of the nebulizers 22 surrounding the main channel 20. In the illustrated embodiment, four nebulizers 22 are provided equidistant from the main channel in an equally-spaced radial design. In addition, the carburetor is approximately round when viewed from above or below, as may be appreciated from FIG. 2, although it is envisioned that other shapes for the carburetor may be used, including a linear rectangular shape, or a square shape, as will become clear later.

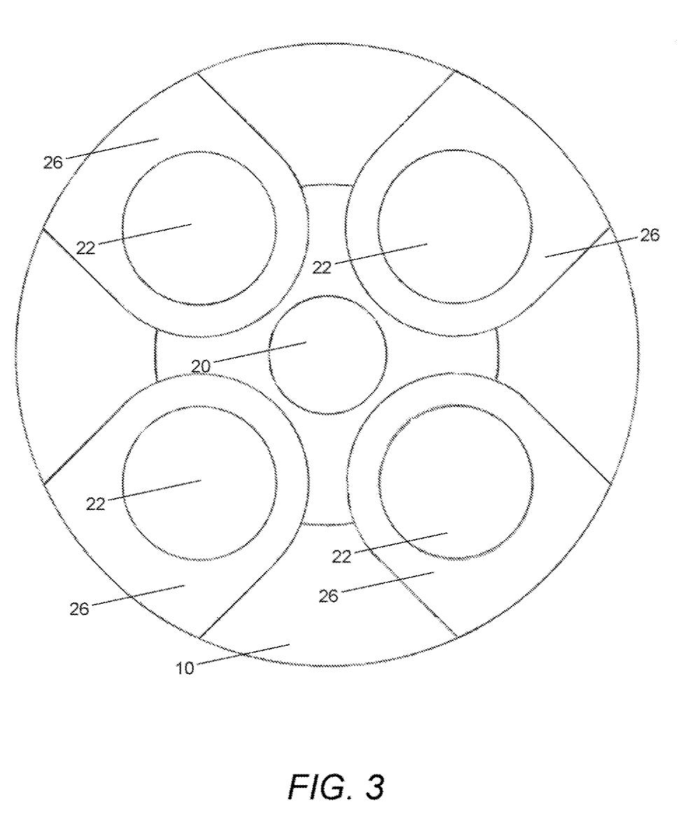

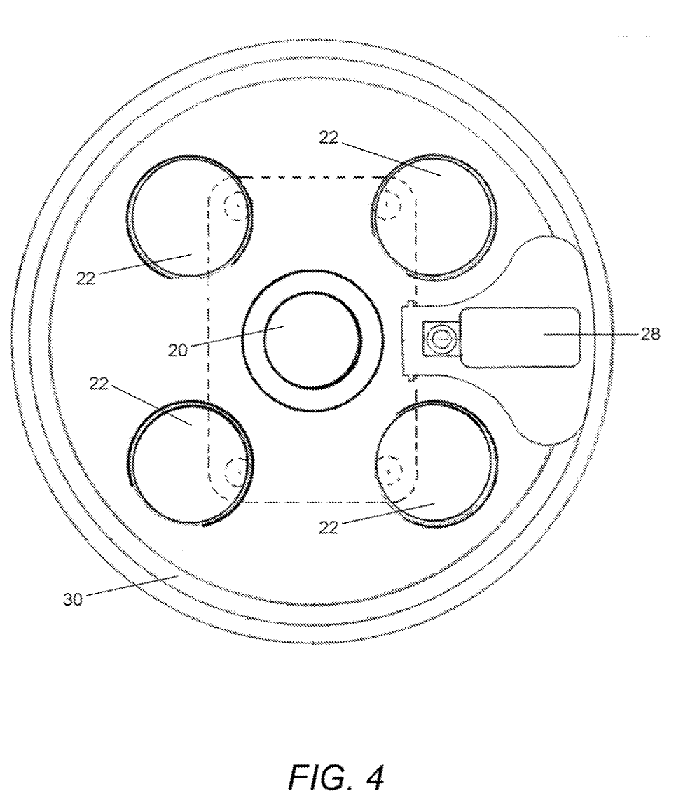

The main body 10 is illustrated from below in FIG. 3, and from above in FIG. 4 showing one embodiment of the locations of the nebulizers 22 surrounding the main channel 20. As may be appreciated from these Figures, the nebulizers 22 rest in nebulizer channels 26 in the main body 10, which nebulizer channels 26 may be narrower near the top of the main body 10 and wider near the bottom of the nebulizer channels 26. FIG. 4 also shows a carburetor float 28 and associated needle valve that rests in a main body fuel reservoir (not shown) in the main body 10 that supplies fuel to the nebulizer channels 26 through a main body fuel channel 30, as will be described below.

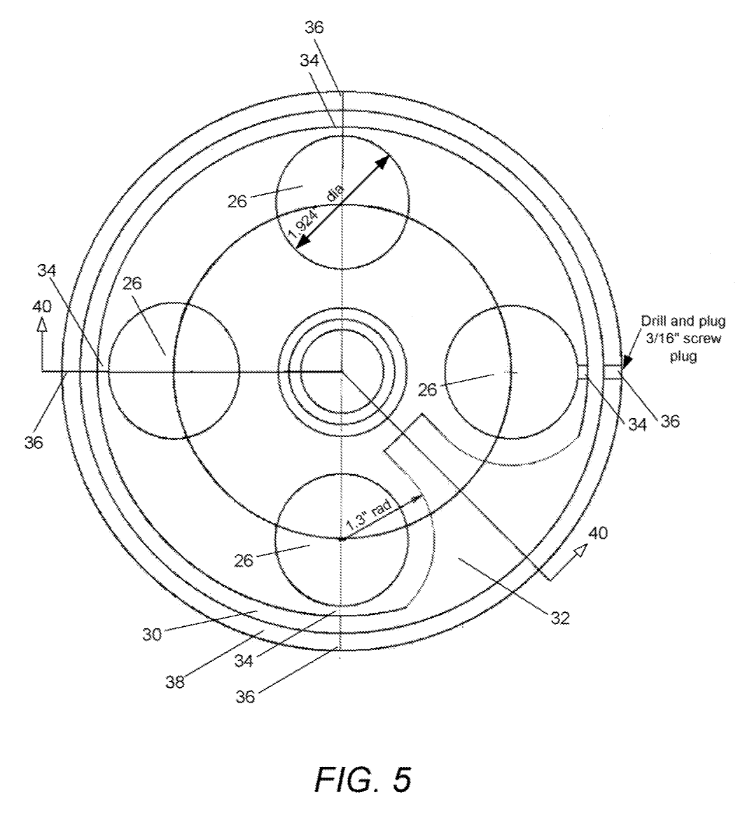

FIG. 5 illustrates the main body 10, as seen from above, similar to the view shown in FIG. 4, but with the carburetor float 28 removed. With the carburetor float 28 removed, a main body fuel reservoir 32 is visible that connects to the main body fuel channel 30. The main body fuel channel 30 encircles the main body 10, and provides a fluid connection between the main body fuel reservoir 32 and each of the nebulizer channels 26 through a fuel supply hole 34. As may be appreciated by one of skill in the art, the fuel supply holes 34 may be provided by drilling a drilled hole 36 in an outer wall 38 of the main body 10 followed by drilling the fuel supply holes 34, and then plugging the drilled hole 36, such as with a screw plug. In the manner shown in FIG. 5, fuel may be supplied to the main body fuel reservoir 32, may pass along the main body fuel channel 30 through the fuel supply holes 34 to the nebulizer channels 26, thus supplying the nebulizers 22 with fuel to nebulize.

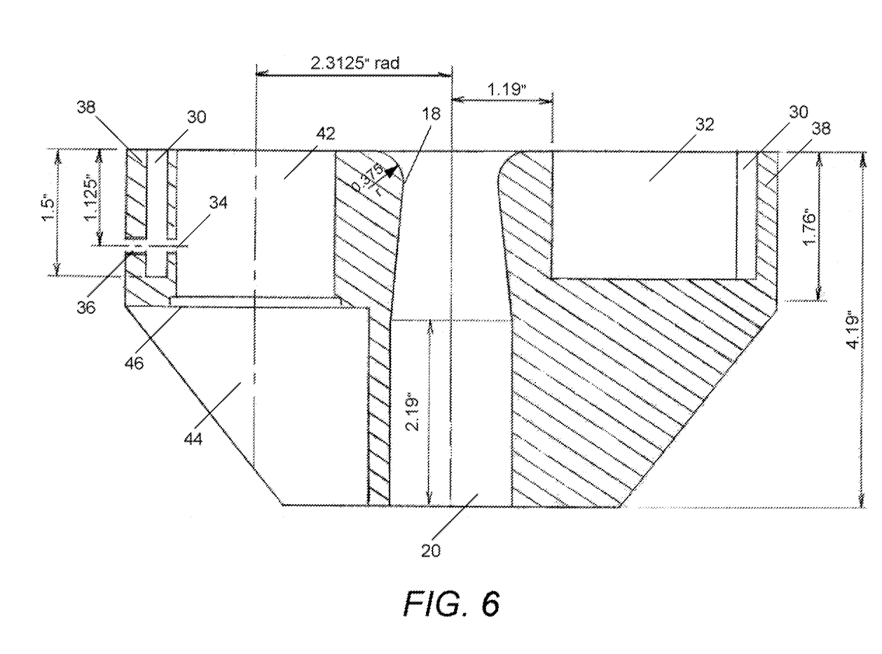

FIG. 6 illustrates a cross-sectional view of the main body 10 taken along cross-sectional line 40-40 shown in FIG. 5. This cross-sectional view shows the main body fuel reservoir 32 and the main body fuel channel 30 on the right, and shows how the main body fuel channel 30 is connected to the nebulizer channel 26 by the fuel supply hole 34 on the left. FIG. 6 also illustrates the main channel 20 and shows the Venturi narrowing 18 in more detail. Finally, FIG. 6 shows the nebulizer channel 26 in more detail, and illustrates that the nebulizer channel 26 includes an upper narrow portion 42, a lower broad portion 44, and a groove 46 for a seal, such as an o-ring seal. The upper narrow portion 42 of the nebulizer channel 26 may house a vibrating plate (not shown) of the nebulizer 22, while the lower broad portion 44 may house a driving mechanism (not shown) of the nebulizer 22 that drives the vibration of the vibrating plate. The groove 46 may house a seal that keeps any fuel in the upper narrow portion 42 from leaking out of the upper narrow portion 42.

In use, fuel fills the main body fuel reservoir 32, as governed by the carburetor float 28. The fuel flows through the main body fuel channel 30 to the nebulizer channels 26, and forms a thin film over the top of each of the vibrating plates. The vibration of the vibrating plates nebulizes the fuel into a mist or fog of very small fuel particles, on the order of a few microns, and this mist or fog of particles is essentially unaffected by gravity and may thus be distributed and mixed into air passing above the nebulizers 22 for combustion. The very fine particles so produced burn more completely and more efficiently than has been accomplished with carbureted engines in the past, and produce fewer emissions. The result is a more-efficient, low-emissions vehicle that obtains a high mileage per unit of fuel than a vehicle equipped with past carburetors. Of course, one of skill in the art will recognize that embodiments of the invention may be used with any engine, not just those associated with vehicles, or with any other application where an improved efficiency or fuel burn may be desired.

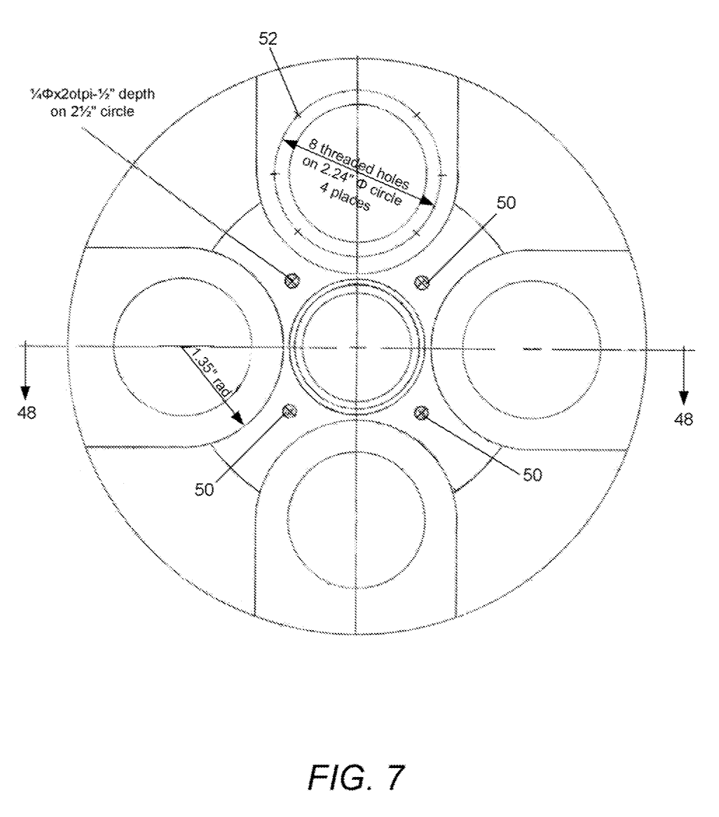

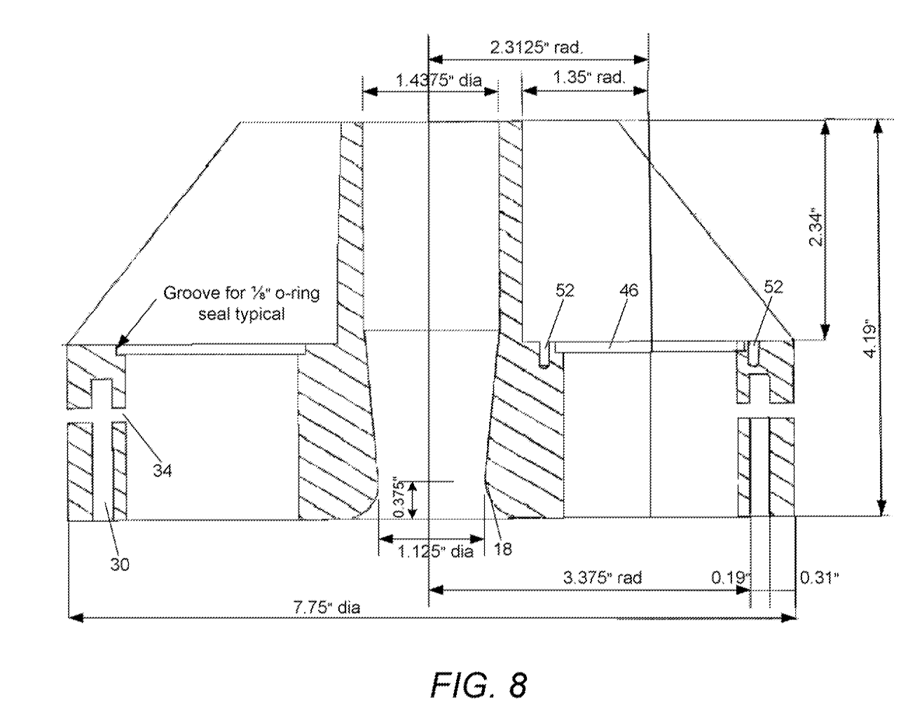

FIG. 7 shows a view of the main body 10 from below with some additional detail, while FIG. 8 shows a cross-sectional view of the main body 10 taken along the cross-sectional line 48-48 shown on FIG. 7. These Figures illustrate attachment points 50 that may be used to secure the main body 10 to the base plate 14, and also attachment points 52 that may be used to secure the nebulizers 22 to the main body 10.

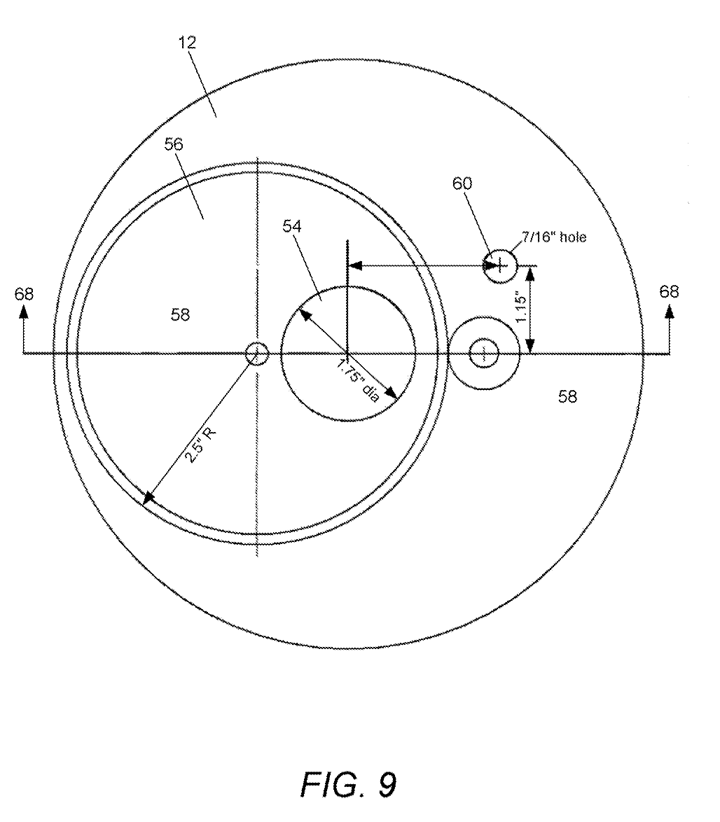

FIGS. 9-12 show various views of the top plate 12. FIG. 9 shows a perspective view of the top plate 12 from above. The top plate 12 includes a top plate center hole 54 corresponding to the main channel 20. The top plate center hole 54 may be substantially larger than other portions of the main channel 20 to avoid any interference by the top plate center hole 54 with the Venturi effect of the Venturi narrowing 18. The top plate center hole 54 may lie within a top plate upper recess 56, which may be offset from the center of the top plate 12 and which may hold an air filter. The top plate 12 may also be provided with one or more mounting holes 58 to permit securing the top plate 12 to the main body 10 and/or to permit securing of other components to the top plate 12. The top plate 12 is also provided with an air intake hole 60 that provides air for mixture with the fuel above the nebulizers 22.

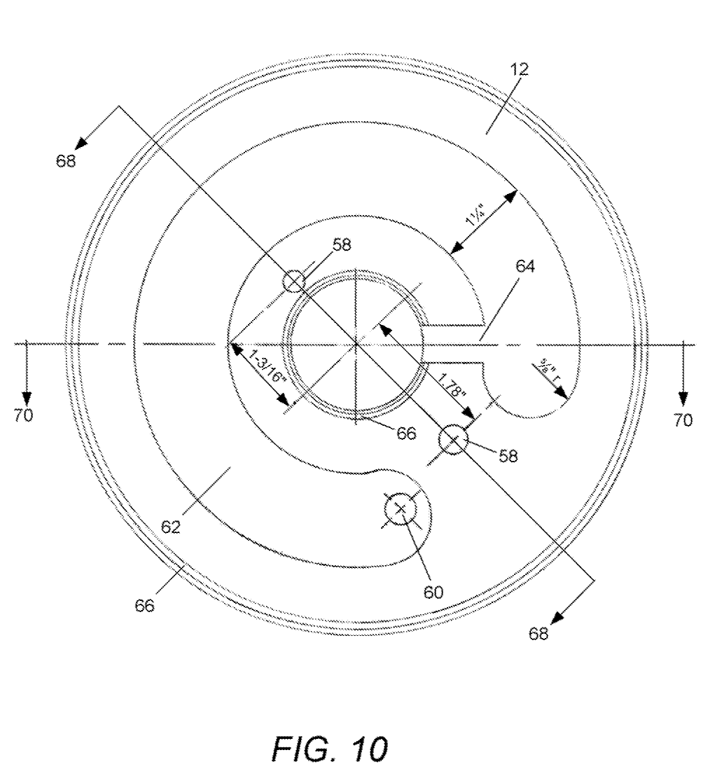

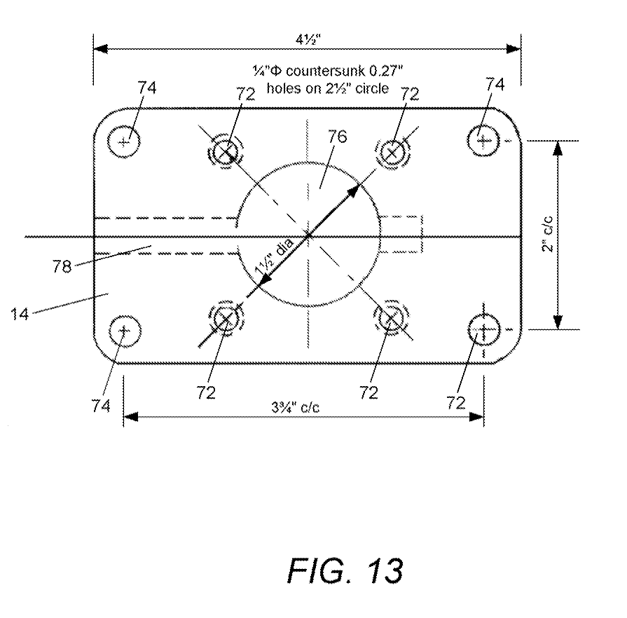

As may be seen in FIG. 10, the air intake hole 60 connects to an air/fuel mixture channel 62 provided in the bottom surface of the top plate 12. FIG. 10 provides a perspective view of the top plate 12 from below, showing that the air/fuel mixture channel 62 has an approximately circular course that begins near the air intake hole 60 and continues slightly more than 270 degrees around the top plate 12 to a nebulized fuel outlet channel 64. The nebulized fuel outlet channel 64 provides a connection to the nebulized fuel outlet 16 in the Venturi narrowing 18, as may be seen and appreciated with reference to FIGS. 1 and 2. To ensure a proper seal between the top plate 12 and the main body 10, the bottom surface of the top plate 12 (or a corresponding top surface of the bottom plate 10) may be provided with one or more o-ring grooves 66, such as at an outer edge of the top plate 12 and at the top plate center hole 54, as is shown in FIGS. 10 and 12.

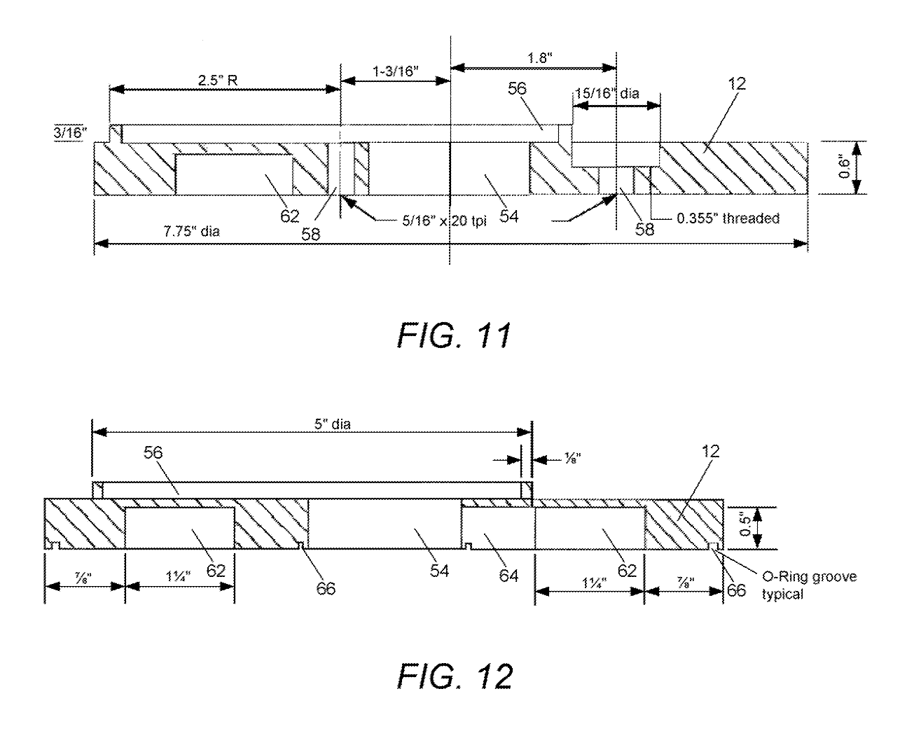

To assist in understanding the configuration of the top plate 12, FIGS. 11 and 12 have been provided showing cross-sectional views of the top plate 12. FIG. 11 shows a cross-sectional view of the top plate 12 taken along the cross-sectional line 68-68 shown in FIGS. 9 and 10, while FIG. 12 shows a cross-sectional view of the top plate 12 taken along the cross-sectional line 70-70 shown in FIG. 10.

As may be appreciated by one of skill in the art by reference to FIGS. 9-12, in conjunction with FIGS. 1-8, the air/fuel mixture channel 62 has a course that passes over each of the four nebulizers 22 in series fashion from the air intake hole 60 to the nebulized fuel outlet channel 64 and thus to the nebulized fuel outlet 16. This course is advantageous in that it provides for better mixing of fuel and air and ensures a consistent amount of nebulized fuel is provided by the carburetor. While a single nebulizer 22 may not consistently provide maximum nebulization of fuel for whatever reason, the provision of three additional nebulizers 22 ensure that any single nebulizer's deficiency/inefficiency is compensated for and protected against. Thus, the passage of intake air over the four nebulizers in serial fashion provides the carburetor with a consistent source of nebulized fuel that burns efficiently and completely due to the small particle size of the nebulized fuel provided to the engine through the nebulized fuel outlet 16.

As may be appreciated by one of skill in the art, the movement of air and/or the air fuel mixture through the air/fuel mixture channel 62 is driven by the Venturi effect of the Venturi narrowing 18 of the main channel 20. The Venturi narrowing 18 causes a reduction in air pressure for air passing through the main channel 20. As the nebulized fuel outlet 16 is located at the Venturi narrowing 18, the nebulized fuel outlet 16 experiences this reduced air pressure. This reduced air pressure draws the air/nebulized fuel mixture from the air/fuel mixture channel 62 through the nebulized fuel outlet channel, and thus causes air to enter the air/fuel mixture channel 62 through the air intake hole 60, which acts as a source of higher-pressure air. The air pressure differential between the air intake hole 60 and the nebulized fuel outlet 16 thus drives air flow through the air/fuel mixture channel 62.

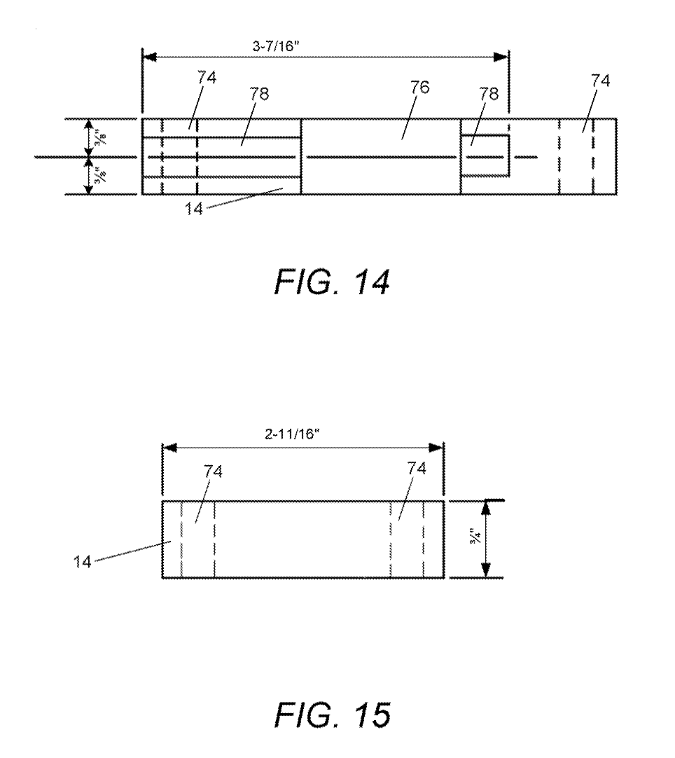

FIGS. 13-15 illustrate perspective top and side views of the base plate 14. As may be appreciated from the Figures and the above discussion, the base plate 14 serves to connect the carburetor to an engine (not shown), and therefore has attachment holes 72 for attaching the base plate 14 to the main body 10 and attachment holes 74 for attaching the base plate 14 to the engine. To permit the flow of fuel and air to the engine, the base plate 14 also includes a base plate center hole 76 and a throttle valve channel 78 intersecting the base plate center hole 76. As is known in the art, a throttle valve 80 (shown in FIG. 1) may be placed in the base plate center hole 76 and rotated to open, totally close, or partially close the base plate center hole 76 by a member extending through the throttle valve channel 78.

The nebulizers 22 may be any type of nebulizer that provides a sufficiently small particle size of the fuel. By way of example, the nebulizers 22 may be of a type typically called ultrasonic. One manufacturer of nebulizers that may be used with embodiments of the invention is Sonaer Inc., which has a place of business at 145 Rome Street Farmingdale, N.Y. 11735. In particular, it is envisioned that Sonaer®'s model 241CST 2.4 MHz ultrasonic nebulizer is a nebulizer that will function appropriately in conjunction with embodiments of the invention. The Sonaer® nebulizer has a stated average particle size of 1.7 microns, and a nebulization rate of approximately 250 milliliters per hour. Therefore, an embodiment of the invention as illustrated in the Figures having four nebulizers 22 could provide up to 1 liter of nebulized fuel per hour of operation. Although other nebulizers and frequencies of nebulizers may be used in conjunction with embodiments of the invention, it is anticipated that the nebulizers used should be capable of providing a sufficient volume of nebulized fuel having an appropriate average and/or maximum particle size for best fuel combustion and efficiency. It is within the skill of one of ordinary skill in the art to evaluate the nebulization and combustion characteristics of various nebulizers for use with embodiments of the invention. For example, one of skill in the art will recognize that the particle size provided by the nebulizers 22 is inversely related to the frequency of vibration, so that higher frequencies will produce a smaller average particle size. Thus, a frequency of vibration of the nebulizer 22 that is too low will not provide a sufficiently small particle size for full combustion.

Based on the above discussion, one of skill in the art may readily understand various modifications of the illustrated embodiment that may be provided and still fall within the spirit and essential characteristics of the present invention. For example, in a case where a particular engine does not require the fuel supply rate delivered by the embodiment discussed above, an alternate embodiment may be provided having fewer nebulizers 22. For example, one embodiment may have two nebulizers 22 and another may have three nebulizers 22 where the illustrated embodiment in the Figures has four nebulizers 22. Regardless of the number of nebulizers, the air/fuel mixture channel 62 passes over each of the nebulizers 22 in serial fashion.

In other alternate embodiments where a greater fuel supply rate is necessary, more than four nebulizers 22 may be used. For example, five, six, seven, eight, or more nebulizers 22 may be used in embodiments of the invention. In one embodiment, a dual carburetor may be provided, where the dual carburetor includes eight nebulizers 22 arranged to have two series of four nebulizers 22 with two independent air/fuel mixture channels 62, one for each of the two series of nebulizers 22. Alternatively, a single air/fuel mixture channel 62 may be used with an embodiment having a greater number of nebulizers 22 than four. It is envisioned, thus, that embodiments of the invention may be scaled for essentially any application and fuel delivery needs.

Although an essentially circular carburetor has been illustrated, it is envisioned that other shapes of carburetors and concomitant arrangements of nebulizers 22 may be provided, as long as the air/fuel mixture channel 62 may serially access the series of nebulizers 22. For example, an approximately square or rectangle carburetor may be provided having four or six nebulizers 22, respectively. In such an arrangement, the air/fuel mixture channel 62 may have one or more straight segments in order to pass over each of the nebulizers 22. In one embodiment, a linear carburetor and air/fuel mixture channel 62 may be provided. Thus, many different embodiments of the carburetor shape and the specific number and arrangement of the nebulizers 22 may be provided. Each such embodiment is embraced by the spirit of the invention.

FIGS. 5-15 include illustrative measurements of various aspects of the specifically-illustrated embodiments of the invention. Such information is provided by way of illustration and not limitation, and is meant solely to aid in the understanding and practice of the embodiments of the invention. One of skill in the art will recognize that the illustrated measurements may be modified according to the specific carburetion needs of various engines, and may thus be increased or decreased as necessary.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A carburetor for an engine comprising:
a main channel for delivering air and fuel to an engine;
a Venturi narrowing in the main channel;
a plurality of fuel nebulizers; and
an air/fuel mixture channel that begins at an air intake, that ends at an outlet located in the Venturi narrowing of the main channel, and that passes over the plurality of fuel nebulizers serially between the air intake and the outlet.

2. The carburetor of claim 1, wherein the plurality of fuel nebulizers comprise four fuel nebulizers.

3. The carburetor of claim 1, wherein the carburetor is substantially circular, the plurality of fuel nebulizers are distributed with circular symmetry around the main channel, and wherein the air/fuel mixture channel has a partially-circular path that passes serially over the plurality of fuel nebulizers.

4. The carburetor of claim 1, further comprising:
a main body housing the plurality of fuel nebulizers; and
a top plate having the air/fuel mixture channel.

5. The carburetor of claim 4, wherein the main body further comprises:
a plurality of nebulizer channels, each nebulizer channel housing a fuel nebulizer;
a main body fuel reservoir; and
a main body fuel channel connecting the main body fuel reservoir to each of the plurality of nebulizer channels, thus supplying fuel to each of the plurality of nebulizers.

6. The carburetor of claim 1, wherein the plurality of nebulizers comprise ultrasonic nebulizers, each of the ultrasonic nebulizers having a flat plate that vibrates at a high frequency to nebulize a thin coating of fuel.

7. The carburetor of claim 6, wherein the high frequency of the nebulizer is a frequency above one megahertz.

8. The carburetor of claim 6, wherein the high frequency of the nebulizer is a frequency of approximately 2.4 megahertz.

9. A carburetor for an engine comprising:
a main channel for providing air and fuel to an engine;
a Venturi narrowing in the main channel;
a main body having a plurality of fuel nebulizers; and
a top plate that incorporates an air/fuel mixture channel that begins at an air intake in the top plate, that ends at an outlet located in the Venturi narrowing of the main channel, and that passes over the plurality of fuel nebulizers serially between the air intake and the outlet.

10. The carburetor of claim 9, wherein the plurality of fuel nebulizers comprise four fuel nebulizers.

11. The carburetor of claim 9, wherein the carburetor is substantially circular, the plurality of fuel nebulizers are distributed with circular symmetry around the main channel, and wherein the air/fuel mixture channel has a partially-circular path that passes serially over the plurality of fuel nebulizers.

12. The carburetor of claim 9, wherein the plurality of fuel nebulizers are substantially aligned in linear fashion, and wherein the air/fuel mixture channel has a linear path that passes serially over the plurality of fuel nebulizers from the air intake to the outlet.

13. The carburetor of claim 9, wherein the plurality of nebulizers comprise ultrasonic nebulizers, each of the ultrasonic nebulizers having a flat plate that vibrates at a high frequency to nebulize a thin coating of fuel.

14. The carburetor of claim 13, wherein the high frequency of the nebulizer is a frequency above one megahertz.

15. The carburetor of claim 13, wherein the high frequency of the nebulizer is a frequency of approximately 2.4 megahertz.

16. The carburetor of claim 9, wherein the main body further comprises:
a plurality of nebulizer channels, each nebulizer channel housing a fuel nebulizer;
a main body fuel reservoir; and
a main body fuel channel connecting the main body fuel reservoir to each of the plurality of nebulizer channels, thus supplying fuel to each of the plurality of nebulizers.

17. A method for providing improved engine combustion and efficiency comprising:
providing a carburetor having a plurality of nebulizers attached to an engine;
delivering fuel to each of the plurality of nebulizers;
nebulizing the fuel at each of the plurality of nebulizers to provide a fog of nebulized fuel at each of the plurality of nebulizers;
passing air over the plurality of nebulizers serially to mix the nebulized fuel and the air into an air/fuel mixture; and
delivering the air/fuel mixture to the engine.

18. The method of claim 17, wherein the step of passing air over the plurality of nebulizers serially comprises:
receiving air at an air intake end of an air/fuel mixture channel of the carburetor;
passing the air down the air/fuel mixture channel over the plurality of nebulizers serially; and
delivering the air/fuel mixture to a Venturi narrowing in a main channel of the carburetor.

19. The method of claim 17, wherein the step of passing air over the plurality of nebulizers serially comprises passing air over four nebulizers serially.

20. The method of claim 17, wherein the step of nebulizing the fuel at each of the plurality of nebulizers comprises:
passing a thin film of fuel over a plate of each of the nebulizers; and
vibrating the plate of each of the nebulizers at a high frequency.
